(19) United States
(12) Patent Application Publication
(10) Pub. No.: US 2012/0042568 A1
(43) Pub. Date: Feb. 23, 2012

(54) Modular expandable growing season augmentation system

(76) Inventor: Gary Keith, Pinedale, AZ (US)

(21) Appl. No.: 13/136,228

(22) Filed: Jul. 26, 2011

Related U.S. Application Data
(60) Provisional application No. 61/518,087, filed on Apr. 28, 2011.
(60) Provisional application No. 61/375,706, filed on Aug. 20, 2010.

(51) Int. Cl. A01G 9/02

(52) U.S. Cl. 47/66.6; 47/86

(57) ABSTRACT

A modular, expandable, growing season augmentation system is described. The system can employ multi-purpose, modular panels to create a free-standing, adjustable shelf system that can be enclosed via an adjustable cover. The shelf system is designed to hold a growth medium in which plants can be nurtured. The system is modular so that a given panel can be employed in numerous roles. Further, the system can be expanded or reduced in size by simply attaching or removing panels and cover components. The cover can be adjusted to minimize the wasted space above the top of the growing plants and can be removed as desired. The cover includes access ports allowing access to the plants therein. Manual or automatic vents can be incorporated in the cover. The cover is supported by an adjustable and removable support structure that can be configured to hold grow lights and/or heating elements.

### CROSS-REFERENCE TO RELATED APPLICATIONS

This application claims the benefit of U.S. Provisional Application No. 61/518,087 entitled “Modular Expandable Growing Season Augmentation System” and filed on Apr. 28, 2011 and U.S. Provisional Application No. 61/375,706 entitled “Extend-a-Season Is a Heated, Raided Bed for Growing Vegetables, with an Expandable Sphere and Adjustable Dome” and filed on Aug. 30, 2010 both of which are incorporated by reference herein for all that they teach and disclose.

### TECHNICAL FIELD

The invention relates generally to gardening and the field of horticulture, and more particularly to a modular, expandable, growing season augmentation system.

### BACKGROUND

People have been practicing horticulture for thousands of years. Traditional methods of preparing a portion of a yard and planting a garden therein are limited by the length of the local growing season (which depends on the latitude and prevailing weather patterns in that area). For example, a garden planted in Florida may experience an almost year-long growing season, while one planted in Anchorage, Ak. may have less than a third of that. One means to overcome overly short growing seasons has been through the use of greenhouses. However, such structures are expensive; usually permanent or at least extremely difficult to disassembly, relocate, and reassemble; require a large commitment of time and energy; and can not be easily expanded or reduced in size as the needs of the user(s) change. For many families, couples, singles, etc., a traditional greenhouse is untenable for one or more of those reasons.

An additional problem with known growing systems is that they often require that a user kneel or otherwise bend over to tend the plants, water, fertilize, weed, etc. Such contortions are uncomfortable for many people and nearly impossible for others. This situation can lead to the plants and growing system being neglected to the point of failure.

What is needed is an inexpensive yet sturdy system that can be easily expanded or reduced in size as plants grow and needs change; is simple to disassemble, transport and reassemble; provides its owner(s) with the ability to grow fruits, vegetables, and other plants without having to bend down or use kneepads; and extends the growing season for a given area by providing a controlled environment that is warmed and protected from frosts and other destructive weather.

### SUMMARY

One embodiment of the present invention provides a modular, expandable, growing season augmentation system. The system can employ multi-purpose, modular, plastic molded-panels to create a free-standing, adjustable shelf system that can be enclosed via a removable transparent and/or translucent adjustable cover. The shelf system is designed to hold soil or other growth medium in which seeds and/or plants can be nurtured. In one embodiment, the system further utilizes a growth medium heater system or a general heater system to further ensure that the plants do not suffer frost damage on cold nights and to stimulate growth. Insulation or other temperature moderation devices can also be incorporated.

The system is modular so that a given panel can be employed in more than one role; for example, a side panel can also be used as a shelf panel. Further, the system can be expanded or reduced in size as desired by the user simply by attaching additional panels to lengthen the overall system. If a panel is damaged or otherwise needs to be replaced, it can be removed and a new panel can be substituted therefore.

The transparent or translucent cover can be adjusted up or down in height to minimize the wasted space between the top of the enclosed plants and the cover itself. As plants grow, the cover can be adjusted upwards and can be easily removed once the danger from frosts and other foul weather has passed. The cover is modular as well and can be easily extended or reduced to fit the size of the shelf units. Furthermore, the cover includes a plurality of access ports to allow a person to access the plants growing on the shelf units in order to weed, water, harvest, etc. One or more vents can be incorporated in the cover (manual or automatic) to ensure that proper temperatures are maintained and fresh supplies of carbon-dioxide rich air are brought in for the plants. Supplemental carbon-dioxide feeding systems can also be incorporated.

The cover is supported by an adjustable and removable support structure that can be configured to hold grow lights and/or heating elements as needed. Furthermore, a water retention system can be incorporated to capture excess water so that it does not leak out of the bottom of the system. In one embodiment, the water retention system includes a drain or hose hookup. In another embodiment, a user can recycle the excess water by reapplying it to the growth medium to water the plants as needed.

### BRIEF DESCRIPTION OF THE DRAWINGS

FIG. 1 shows a perspective view of an exemplary embodiment of a modular expandable growing season augmentation system with a cover in a lowered position;

FIG. 2 illustrates a perspective view of another exemplary embodiment of a modular expandable growing season augmentation system;

FIG. 3 illustrates a perspective view of an exemplary embodiment of a modular expandable growing season augmentation system with the cover extended;

FIG. 4 illustrates a front elevation view of an exemplary embodiment of a modular expandable growing season augmentation system;

FIG. 5 illustrates a rear elevation view of an exemplary embodiment of a modular expandable growing season augmentation system;

FIG. 6 illustrates a right side elevation view of an exemplary embodiment of a modular expandable growing season augmentation system;

FIG. 7 illustrates a left side elevation view of an exemplary embodiment of a modular expandable growing season augmentation system;

FIG. 8 illustrates a top plan view of an exemplary embodiment of a modular expandable growing season augmentation system;

FIG. 9 illustrates a bottom plan view of an exemplary embodiment of a modular expandable growing season augmentation system;

FIG. 10 illustrates a perspective view of an exemplary embodiment of a modular expandable growing season augmentation system with the cover, front and right sides removed;

FIG. 11 illustrates a close-up, perspective view of an exemplary embodiment of a modular expandable growing season augmentation system with the cover, front center panel, center shelf panel, and right side panel removed;

FIG. 12 illustrates a close-up, perspective view of an exemplary embodiment of a modular expandable growing season augmentation system with the cover, front center panel, front right panel, center shelf panel, and right side panel removed;

FIG. 13 illustrates a perspective view of an exemplary embodiment of a modular expandable growing season augmentation system with the cover, front panels, center and left shelf panels, right side panel, and left rear panel removed;

FIG. 14 illustrates a close-up, cross-section view of an exemplary embodiment of a modular expandable growing season augmentation system showing only the bottom right panel, rear center and right panels, and right shelf panel;

FIGS. 15A and 15B illustrate perspective views of a standard panel that can be used in an exemplary embodiment of a modular expandable growing season augmentation system, wherein the panel can be used as a front panel, a rear panel, or a shelf panel;

FIG. 16A illustrates a perspective view of a standard panel that can be used in an exemplary embodiment of a modular expandable growing season augmentation system, wherein the panel can be used as a front panel, a rear panel, or a shelf panel;

FIG. 16B illustrates a side elevation view of a standard panel that can be used in an exemplary embodiment of a modular expandable growing season augmentation system, wherein the panel can be used as a front panel, a rear panel, or a shelf panel;

FIGS. 17A and 17B illustrate perspective views of an end panel that can be used in an exemplary embodiment of a modular expandable growing season augmentation system;

FIGS. 18A and 18B illustrate perspective views of a bottom panel that can be used in an exemplary embodiment of a modular expandable growing season augmentation system; and

FIG. 19 illustrates a perspective view of an exemplary embodiment of a modular expandable growing season augmentation system showing one embodiment of a growth medium heating system with the cover, front and right sides removed.

### DETAILED DESCRIPTION

In the following discussion, numerous specific details are set forth to provide a thorough understanding of the present invention. However, those skilled in the art will appreciate that the present invention may be practiced without such specific details. Furthermore, lists and/or examples are often provided and should be interpreted as exemplary only and in no way limiting embodiments to only those examples.

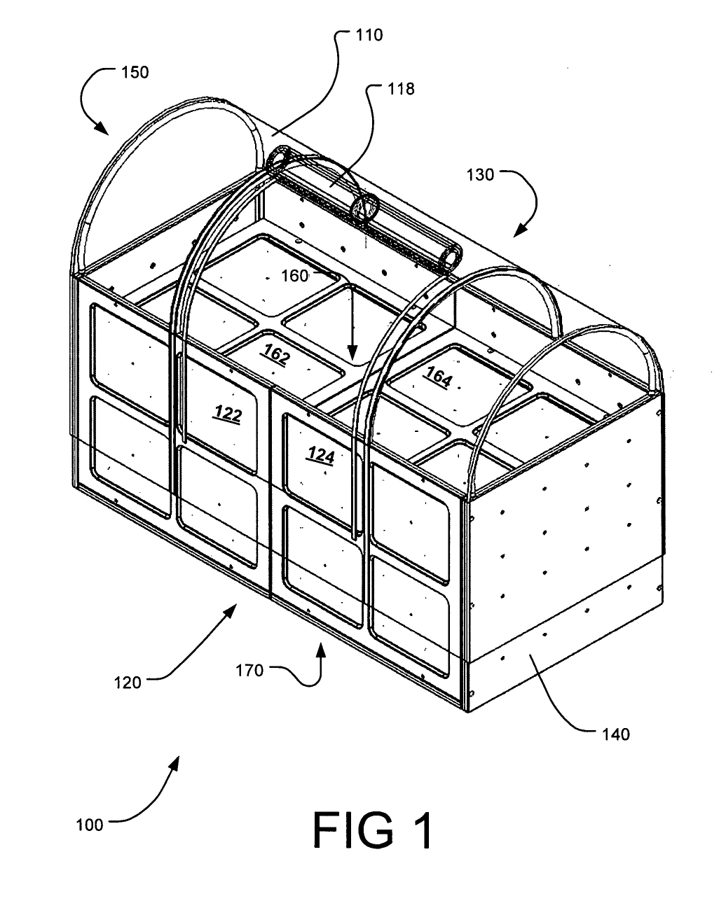

Referring now to the drawings, FIG. 1 shows a perspective view of an exemplary embodiment of a modular expandable growing season augmentation system 100 with a cover in a lowered position. The system can comprise a plurality of panels that provide the structure and strength of the system. In one embodiment, the panels are formed of two layers of strong plastic having a hollow air space between them. In other embodiments, other materials are utilized and have different shapes but function similarly.

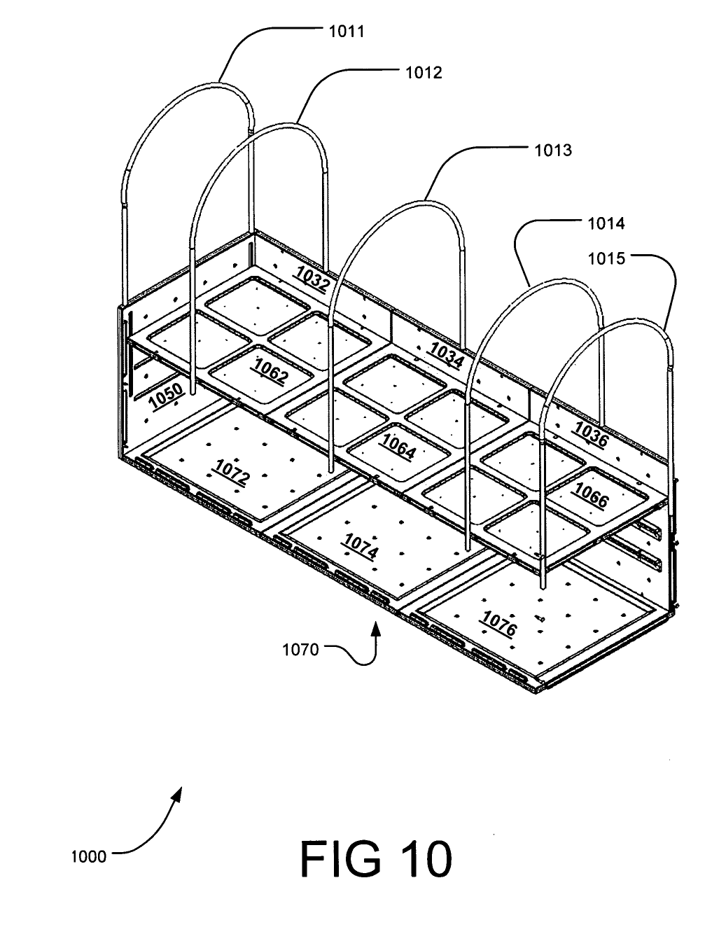

As illustrated in FIG. 1, the system can have a left front panel 122 and a right front panel 124. In other embodiments, the system can utilize only one front panel or more than the two front panels 122 and 124 shown in FIG. 1. The plurality of front panels 122 and 124 are removably attached to the bottom panels 170. The right side panel 140 attaches to both the right front panel 124 and the right bottom panel 174 (not specifically shown in FIG. 10, item 1076—note that in FIG. 10, an exemplary system based on a three-panel long structure is illustrated whereas in FIG. 1, a two-panel long structure is illustrated).

Attached to the other upright edge of the right side panel 140 is the rear panel combination 130. Similarly, the left side panel 150 is attached to the left of the rear panel combination 130, the left of the bottom panel combination 170 and the left front panel 122. Together, the bottom panels 170, right side panel 140, left side panel 150, front panels 122 and 124, and rear panels 130 form a five-sided, generally rectangular, box having an open top. The shelf 160 comprises a plurality of panels 162 and 164 that fit inside the box and can be positioned at various levels as needed. The cover 110 fits over the structure to protect the plants that will be grown on the shelf 160 and to retain heat within the structure. The cover 110 has a plurality of access ports 118 that can be opened in order to provide access to the interior of the system, as desired.

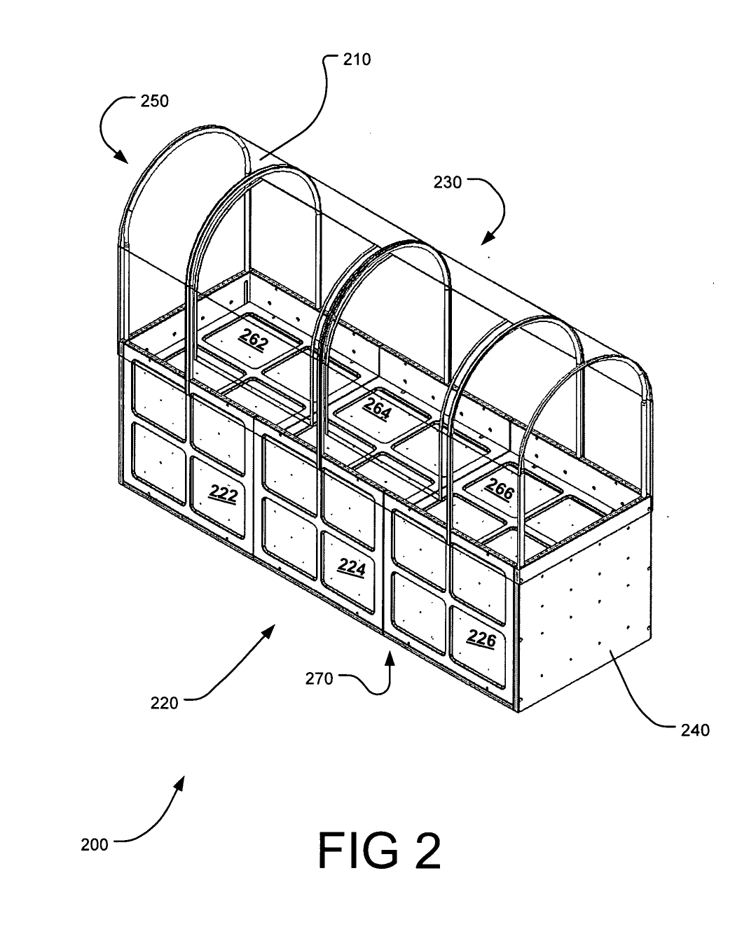

FIG. 2 illustrates a perspective view of another exemplary embodiment of a modular expandable growing season augmentation system 200. The cover 210 in FIG. 2 is shown in the fully extended position, thereby providing enhanced vertical interior space for growing plants. When compared to FIG. 1, it is easy to see that the cover 210 is designed to retract and extend as required by the needs of the users of the system 200.

The system 200 shown in FIG. 2 is three-panels-long as compared to the two-panels-long system 100 of FIG. 1—other length systems are contemplated. Further, since the system 200 is modular, a user can simply insert additional panels to lengthen the system 200 to his or her desired length. Although the system 200 is structurally sound as illustrated, if the combination of heavy amounts of growth medium, water, fertilizer and the plants themselves will stress the structure, support posts can be added between the shelf panels 262, 264 and 266 and the remainder of the system 200. The components illustrated in FIG. 2 include a set of front panels 220 (including a left front panel 222, a center front panel 224, and a right front panel 226), a right side panel 240, a left side panel 250, a set of bottom panels 270, a set of rear panels 230, a left shelf panel 262, a center shelf panel 264, a right shelf panel 266, and a cover 210.

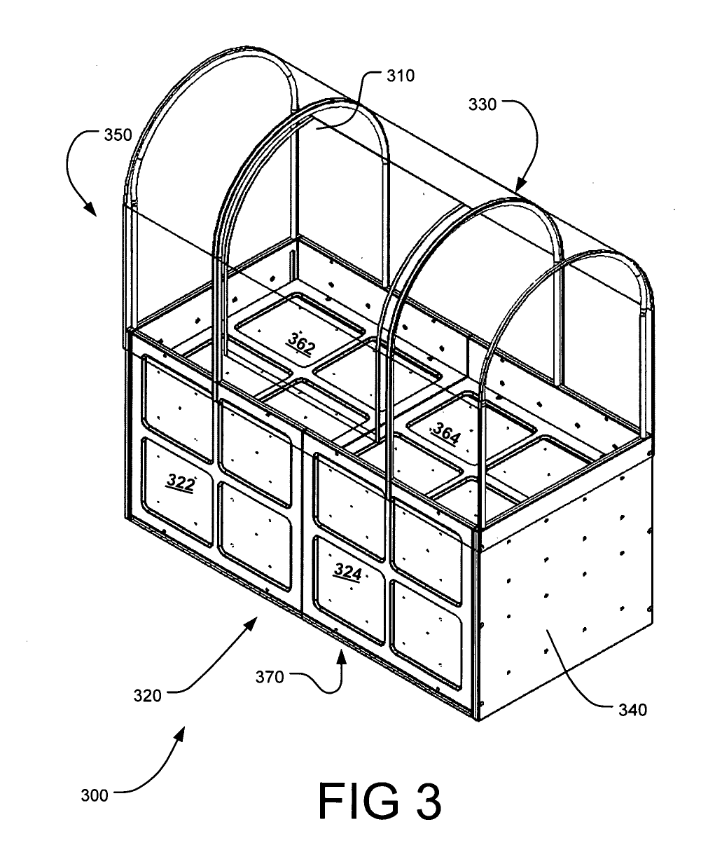

FIG. 3 illustrates a perspective view of an exemplary embodiment of a modular expandable growing season augmentation system 300 with the cover extended. As in FIG. 1, the system 300 illustrated in FIG. 3 is a two-panel-long system; comparisons between FIGS. 1 and 3 will highlight the extension and retraction capabilities of the cover 110/310. The components illustrated in FIG. 3 include a set of front panels 320 (including a left front panel 322 and a right front panel 324), a right side panel 340, a left side panel 350, a set of bottom panels 370, a set of rear panels 330, a left shelf panel 362, a right shelf panel 364, and a cover 310.

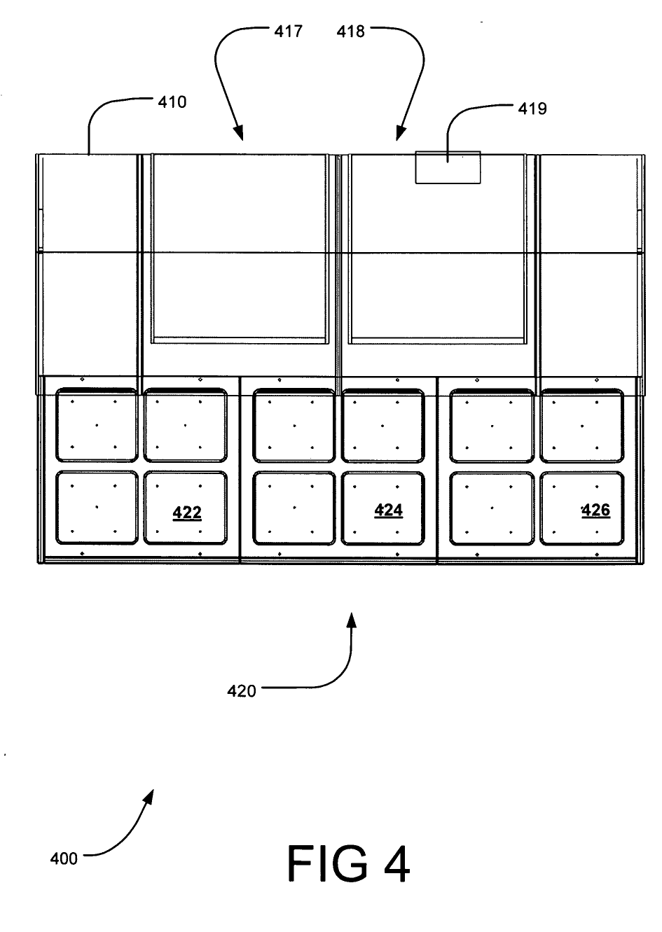

FIG. 4 illustrates a front elevation view of an exemplary embodiment of a modular expandable growing season augmentation system 400. The front panels 420 shown in FIG. 4 include a left front panel 422, a center front panel 424, and a right front panel 426. The cover 410 is illustrated as are two access ports 417 and 418. In the exemplary embodiment shown in FIG. 4, the right access port 419 includes a ventilation port 419. This ventilation port 419 is shown as being an opening in the cover that can be manually opened and closed as needed. In other embodiments, an automated ventilation system can be utilized including a plurality of ventilation ports, electric fans, thermostats, carbon dioxide sensors, actuators, temperature and humidity sensors, etc.

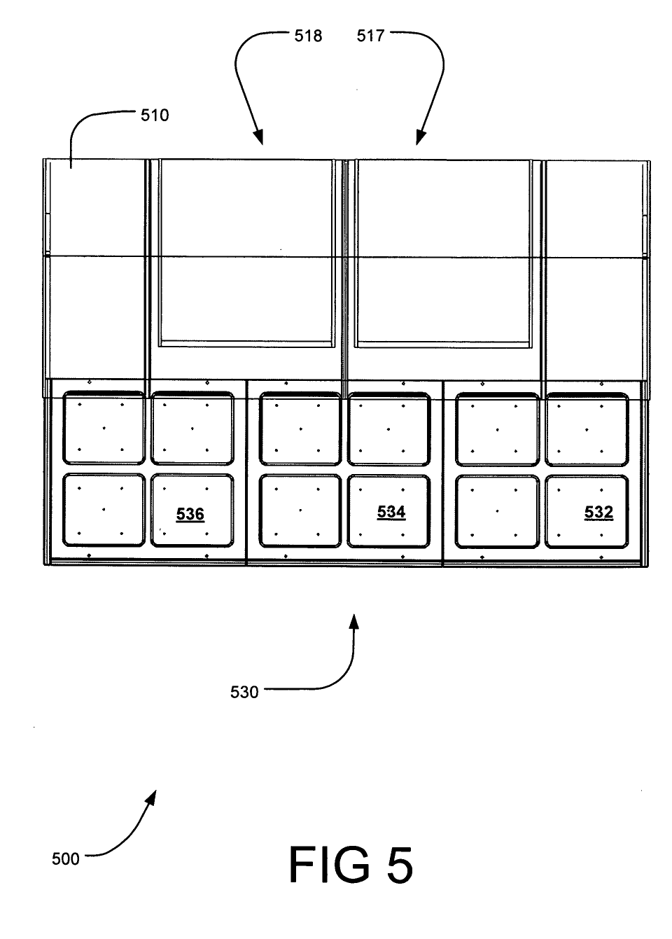

FIG. 5 illustrates a rear elevation view of an exemplary embodiment of a modular expandable growing season augmentation system 500. The rear panels 530 shown in FIG. 5 include a right rear panel 532, a center rear panel 534, and a left rear panel 536. The cover 510 is illustrated as are two access ports 517 and 518.

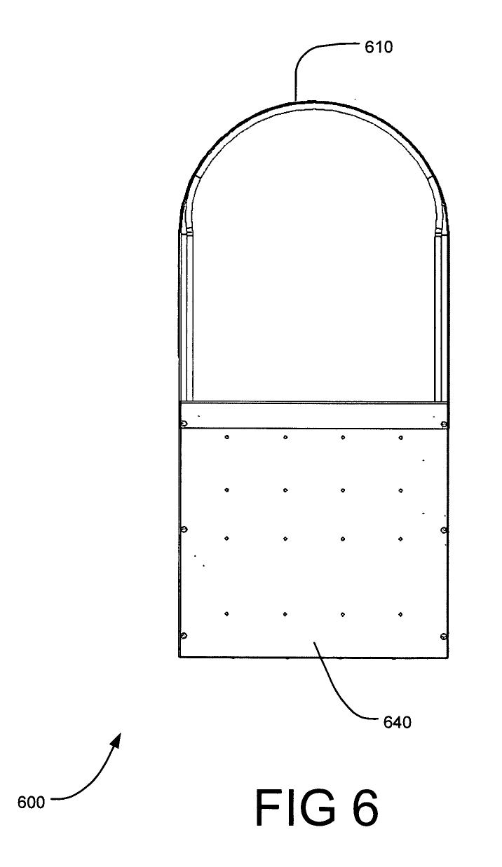

FIG. 6 illustrates a right side elevation view of an exemplary embodiment of a modular expandable growing season augmentation system 600. The right side panel 640 and the cover 610 are illustrated.

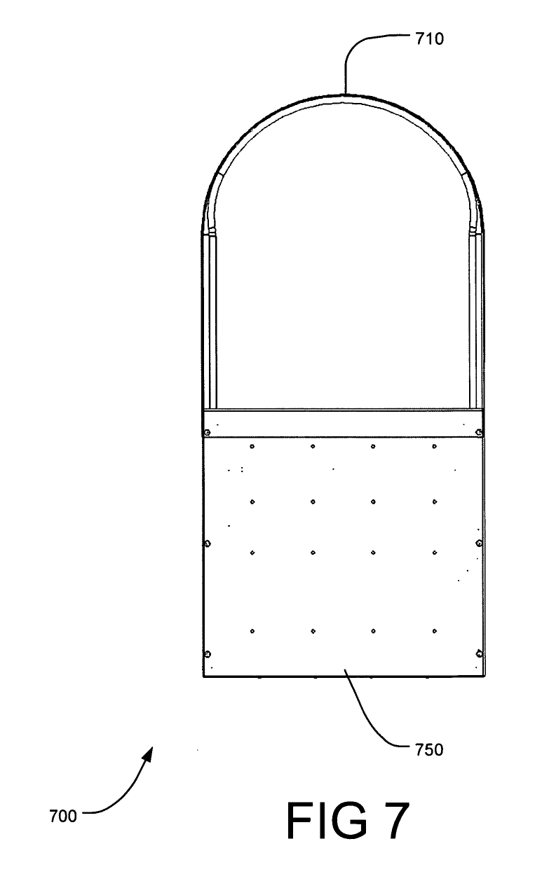

FIG. 7 illustrates a left side elevation view of an exemplary embodiment of a modular expandable growing season augmentation system 700. The left side panel 750 and the cover 710 are illustrated.

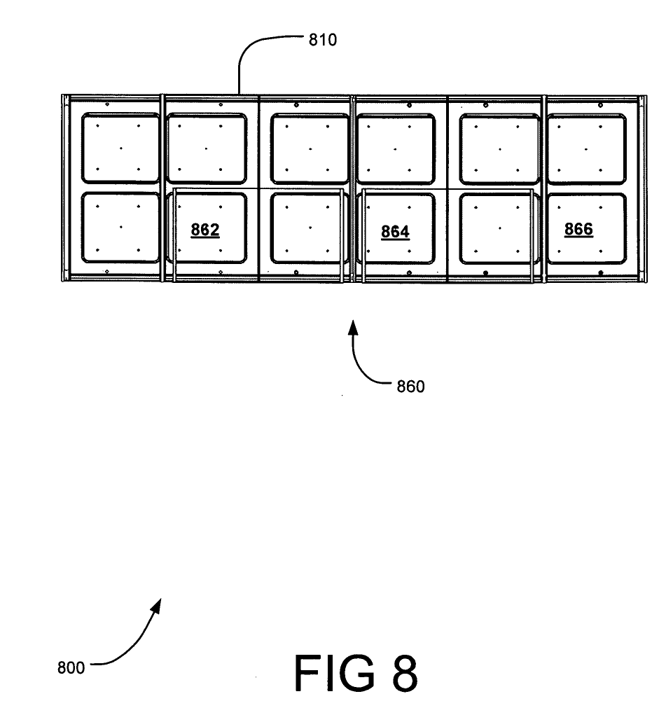

FIG. 8 illustrates a top plan view of an exemplary embodiment of a modular expandable growing season augmentation system 800. Since the cover 810 can be designed to be transparent and/or translucent, this view provides a look down through the cover 810. The shelf 860 comprises a left shelf panel 862, center shelf panel 864, and right shelf panel 866.

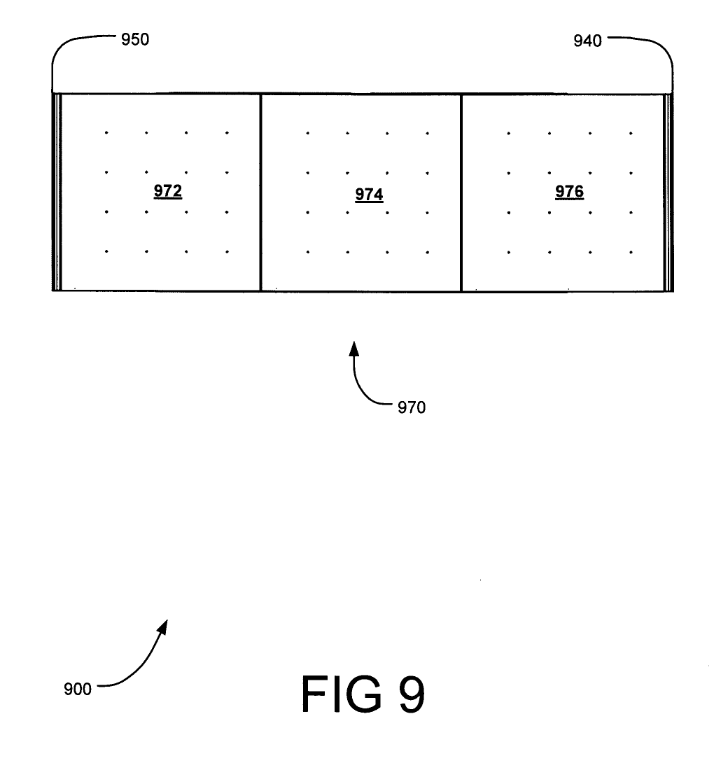

FIG. 9 illustrates a bottom plan view of an exemplary embodiment of a modular expandable growing season augmentation system 900. The bottom panels 970 are illustrated, comprising a left bottom panel 972, a center bottom panel 974, and a right bottom panel 976. Also shown are the bottom edges of the right side panel 940 and the left side panel 950. The sixteen “dots” shown on each panel can be included as ventilation and water drainage pathways. They are channels that bore through the panels. In other embodiments, more or fewer dots can be employed.

FIG. 10 illustrates a perspective view of an exemplary embodiment of a modular expandable growing season augmentation system 1000 with the cover, front and right sides removed. The bottom panels 1070 (comprising the left bottom panel 1072, the center bottom panel 1074, and the right bottom panel 1076), left side panel 1050, left rear panel 1032, center rear panel 1034, right rear panel 1036, left shelf panel 1062, center shelf panel 1064, and right shelf panel 1066 are all illustrated in FIG. 10. Also shown clearly in FIG. 10 are the hoop cover support structures 1011, 1012, 1013, 1014, and 1015. These hoops extend down, into the front, rear and side panels and can be extended or retracted in order to raise or lower, respectively, the cover. Furthermore, the hoops 1011-1015 can be completely removed along with the cover if desired. Although not shown in FIG. 10, the hoops can also provide support points for hanging or attaching grow lights and/or heat elements inside the system 1000. Such enhancements can be automatically controlled via timers, thermostats, etc. Additionally, a watering subsystem, fertilizing subsystem, pest control subsystem, humidifier, dehumidifier, and/or air conditioning units can be added to the system 1000 as well.

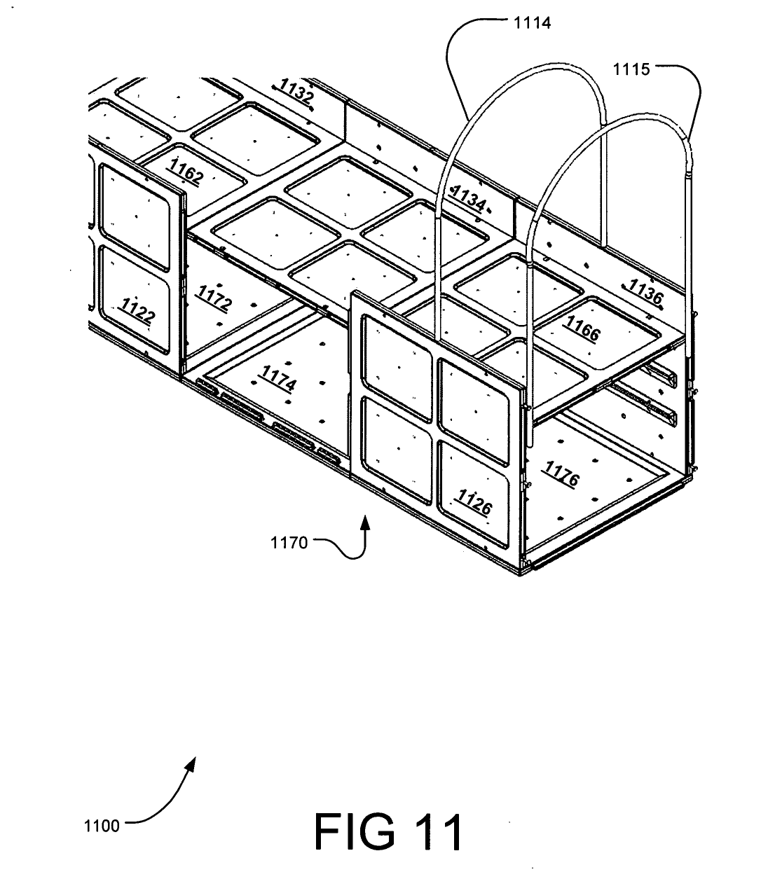

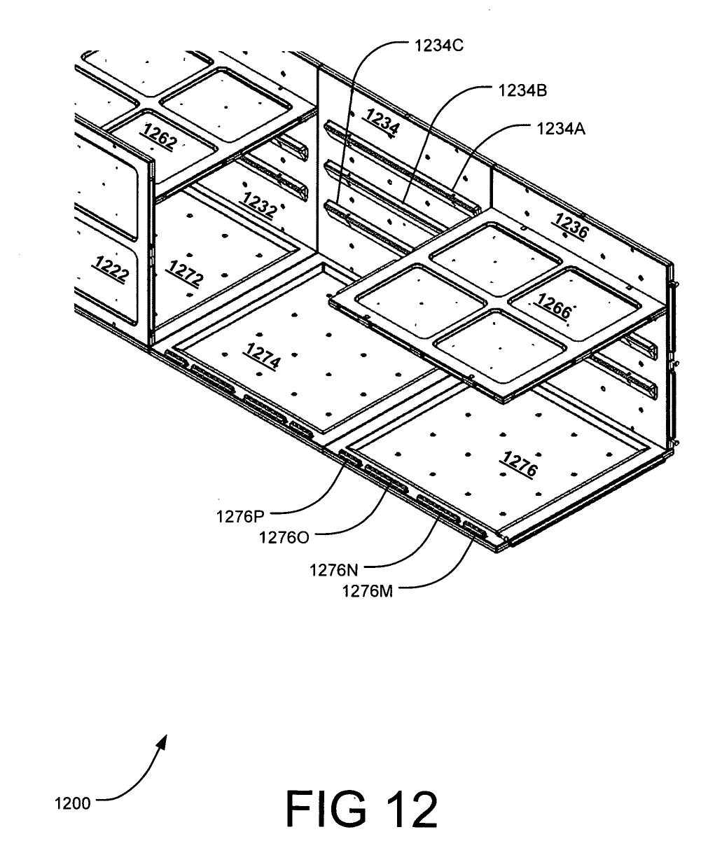

FIG. 11 illustrates a close-up, perspective view of an exemplary embodiment of a modular expandable growing season augmentation system 1100 with the cover, front center panel, center shelf panel, and right side panel removed. In this view, the shelf supports of the rear panels 1132, 1134 and 1136 can be seen (for more detail, see FIG. 12). Also shown in FIG. 11 are the left shelf panel 1162, the right shelf panel 1164, two hoop cover support structures 1114 and 1115, the bottom panels 1170 (including the left bottom panel 1172, the center bottom panel 1174, and the right bottom panel 1176), the left front panel 1122, and the right front panel 1126.

FIG. 12 illustrates a close-up, perspective view of an exemplary embodiment of a modular expandable growing season augmentation system 1200 with the cover, front center panel, front right panel, center shelf panel, and right side panel removed. In addition to the standard components previously illustrated (left front panel 1222, left bottom panel 1272, center bottom panel 1274, right bottom panel 1276, left shelf panel 1262, right shelf panel 1266, left rear panel 1232, center rear panel 1234, and right rear panel 1236), FIG. 12 includes some examples of possible shelf support members 1234A, 1234B, and 1234C. As shown in this embodiment, the shelf support members are integrated into the front and rear panels. In other embodiments, the shelf support members are configured differently and may or may not be integrated into the front and rear panels.

Another new component illustrated in FIG. 12 are the vertical support tabs 1276M, 1276N, 1276O, and 1276P near the front edge of the right bottom panel 1276. These tabs fit into the bottom edge of the front and rear panels that attach to each of the bottom panels. In other embodiments, other means of supporting and attaching the front and rear panels to the bottom panels are contemplated.

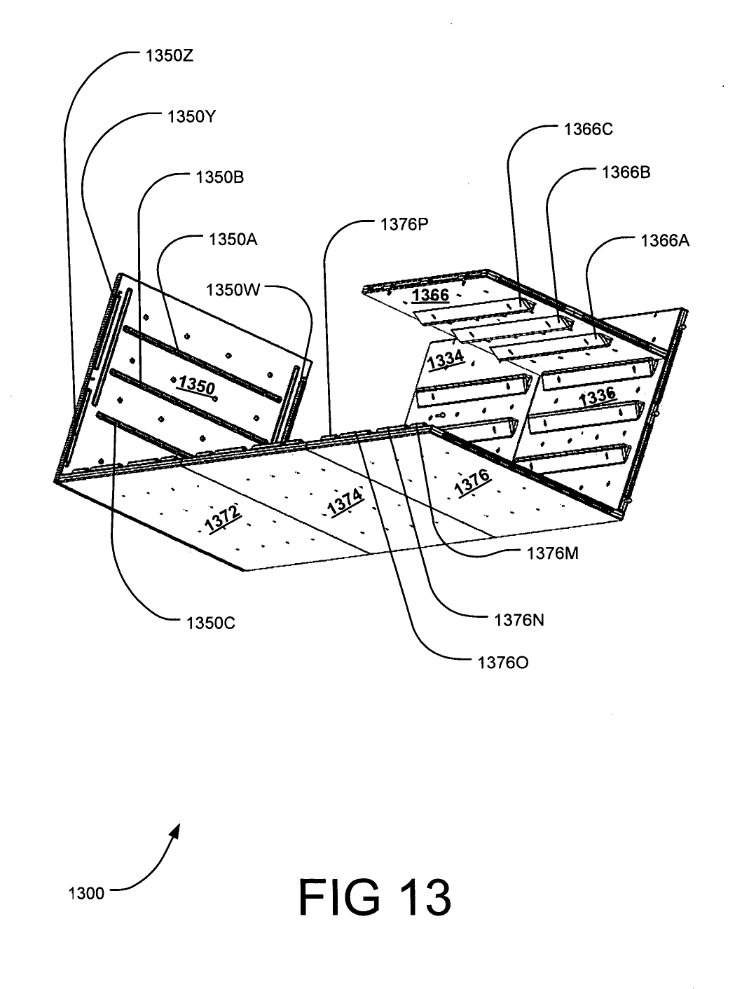

FIG. 13 illustrates a perspective view of an exemplary embodiment of a modular expandable growing season augmentation system 1300 with the cover, front panels, center and left shelf panels, right side panel, and left rear panel removed. The components shown include those previously described above as well as the strengthening members 1366A, 1366B, and 1366C shown on the underside of the right shelf panel 1366. In this embodiment, the similarities between the shelf panels and the rear panels can be seen.

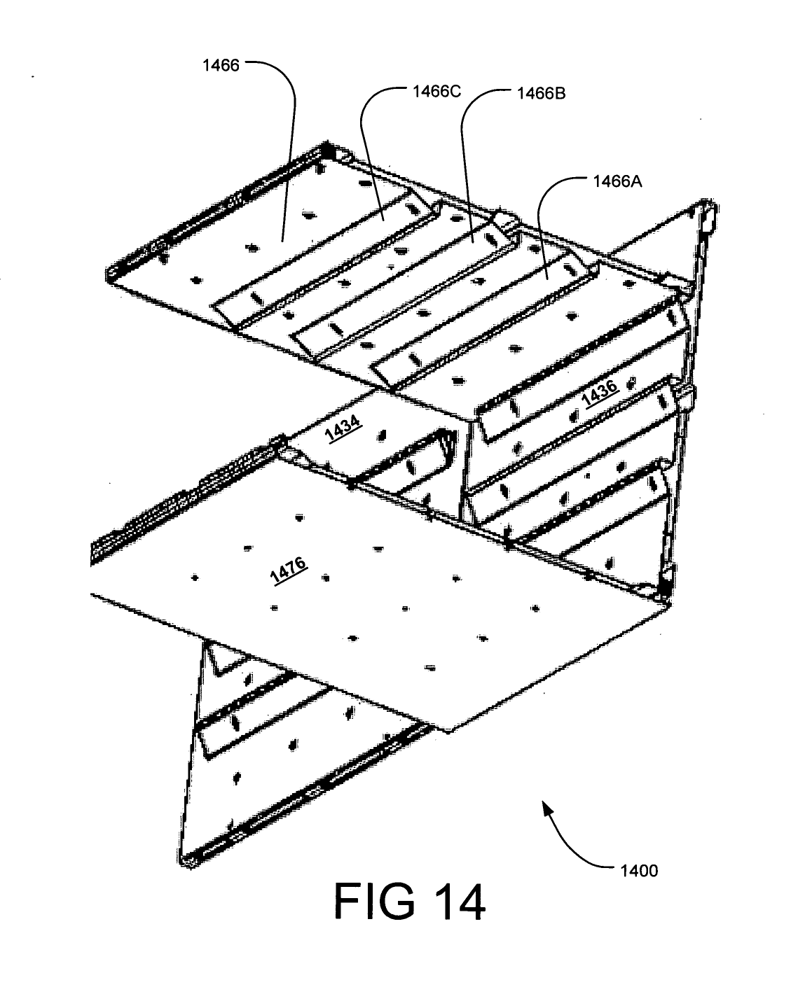

FIG. 14 illustrates a close-up, cross-section view of an exemplary embodiment of a modular expandable growing season augmentation system 1400 showing the bottom right panel 1476, rear right panel 1436, and right shelf panel 1466 in cross section. In the exemplary embodiment of FIG. 14, the panels are manufactured in a two-layered design as illustrated in the cross section. The strengthening members 1466A, B, and C can be seen in detail on the underside of the right support shelf 1466. Also, the “dots” in the panels can now be clearly seen as the conduits that they are, although in other embodiments the number, size, location, etc. of the dots can vary and there can be zero, one, two, or more dots per panel.

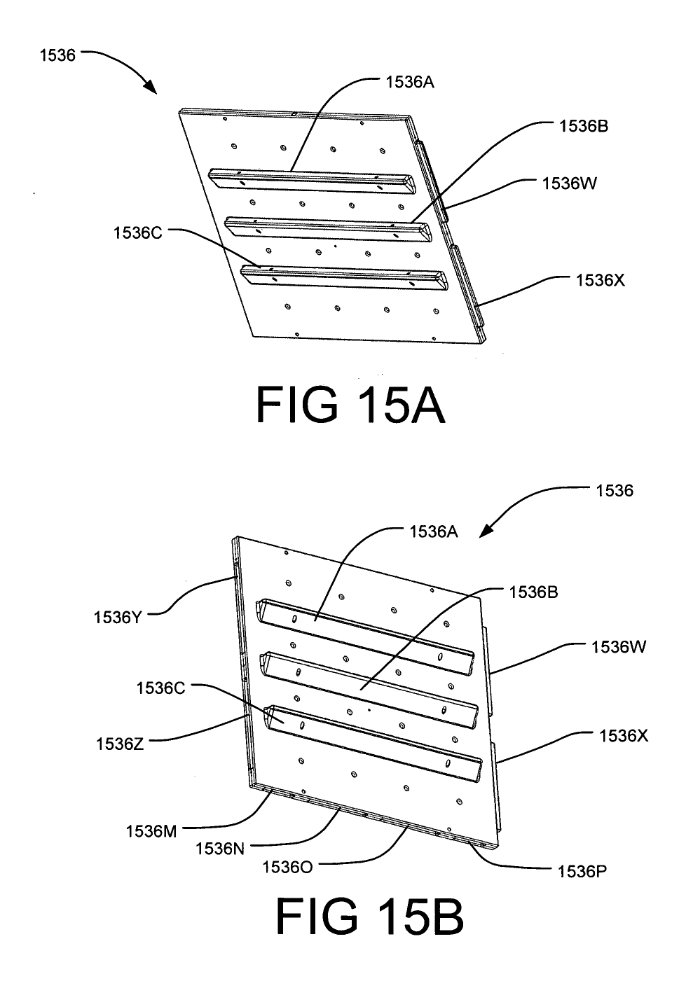

FIGS. 15A and 15B illustrate perspective views of a standard panel 1536 that can be used in an exemplary embodiment of a modular expandable growing season augmentation system, wherein the panel can be used as a front panel, a rear panel, or a shelf panel. The panel 1536 has three shelf supports which also function as strengthening members 1536A, B, and C. Further, the panel has two structural tabs 1536W and 1536W which strengthen the attachment made between panels. On the edge opposite the tabs 1536W and X are the slots 1536Y and 1536Z. The tabs W and X fit the slots Y and Z of the next panel.

Similarly, the plurality of bottom slots 1536P, O, N, and M fit the vertical support tabs extending upwards from the bottom panels (see previous drawings).

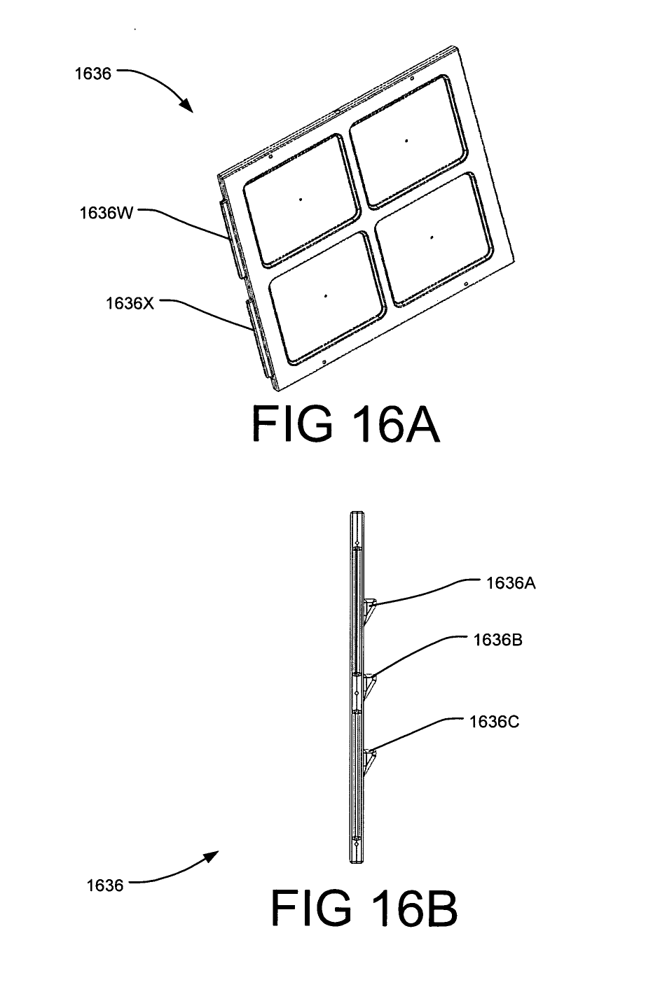

FIG. 16A illustrates a perspective view of a standard panel 1636 that can be used in an exemplary embodiment of a modular expandable growing season augmentation system, wherein the panel can be used as a front panel, a rear panel, or a shelf panel. The tabs 1636W and X are illustrated as is the exterior side of the panel 1636 itself.

FIG. 16B illustrates a side elevation view of a standard panel 1636 that can be used in an exemplary embodiment of a modular expandable growing season augmentation system, wherein the panel can be used as a front panel, a rear panel, or a shelf panel. The shelf support members 1636A, 1636B, and 1636C are shown in profile.

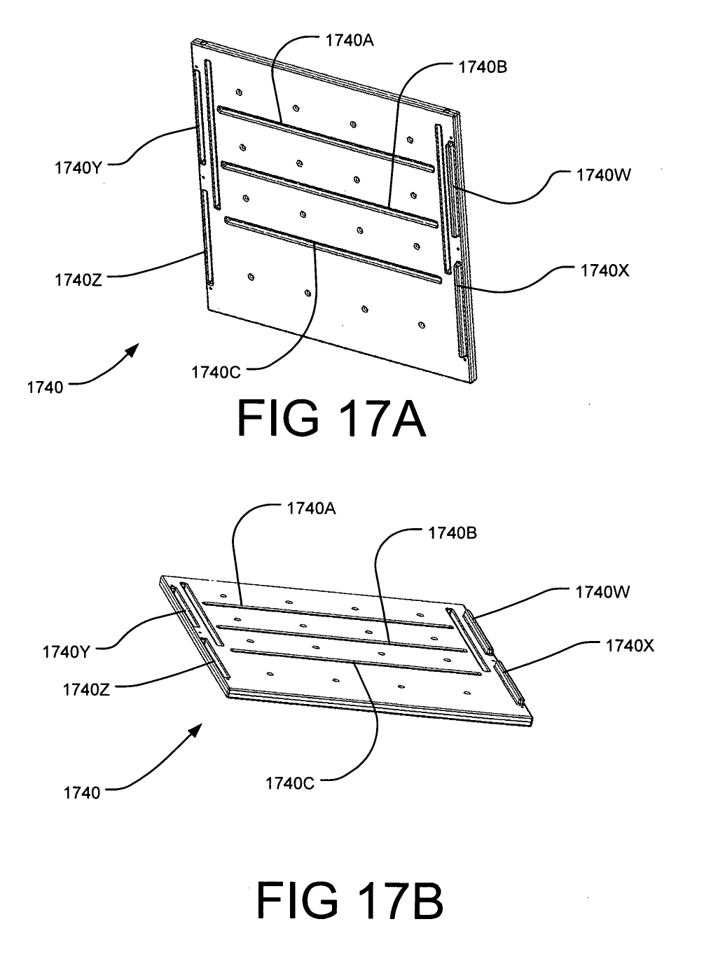

FIGS. 17A and 17B illustrate perspective views of an end panel 1740 that can be used in an exemplary embodiment of a modular expandable growing season augmentation system. The end panel 1740 has slots 1740Y and 1740Z into which fit the tabs of the standard rear or front panels as described above. Similarly, the end panel 1740 has two of its own tabs 1740W and 1740X to fit the slots in the other connecting rear or front panels. Additionally, shelf support members 1740A, 1740B, and 1740C are illustrated; these can be slots, protrusions, etc.

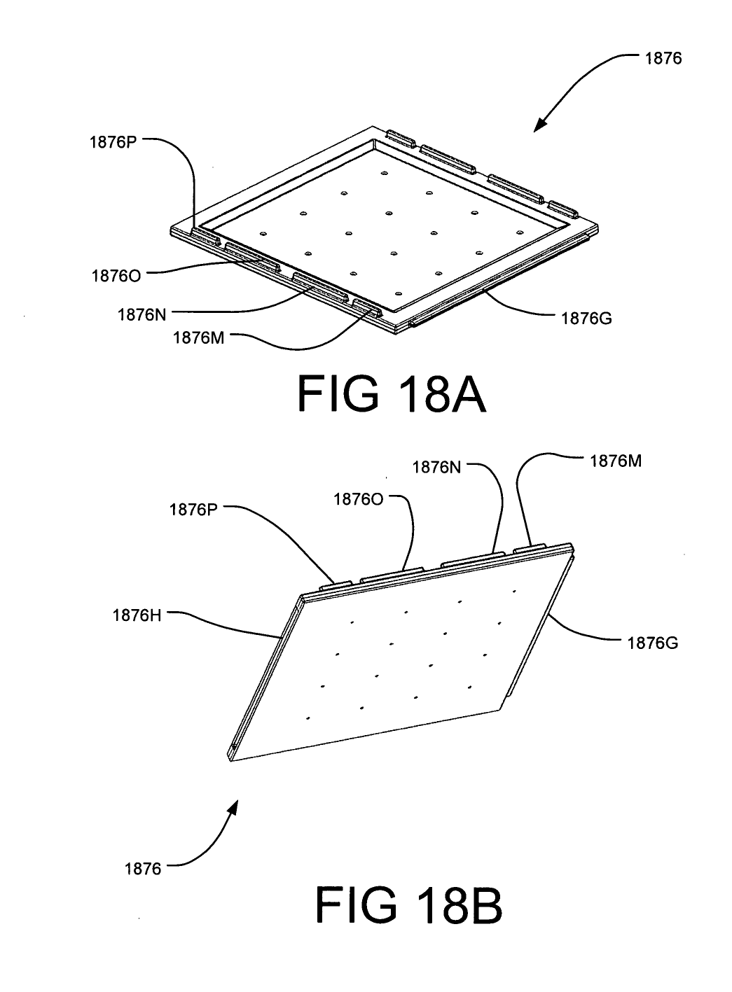

FIGS. 18A and 18B illustrate perspective views of a bottom panel 1876 that can be used in an exemplary embodiment of a modular expandable growing season augmentation system. The upright bottom tabs 1876M, 1876N, 1876O, and 1876P are shown as is the bottom horizontal tab 1876G and bottom horizontal slot 1876H. The horizontal tab G of one bottom panel fits into the horizontal slot H of the next bottom panel. Although not shown, the tab G and slot H can also be incorporated into the right side panel and left side panel of the system in order to fully engage the bottom panels to the side panels. The system is designed to be easily assembled and disassembled using the slots, tabs, support members, etc. as described above. Additionally, screws, bolts, snap-tight fittings, and other connecting hardware can be incorporated to further strengthen the structure.

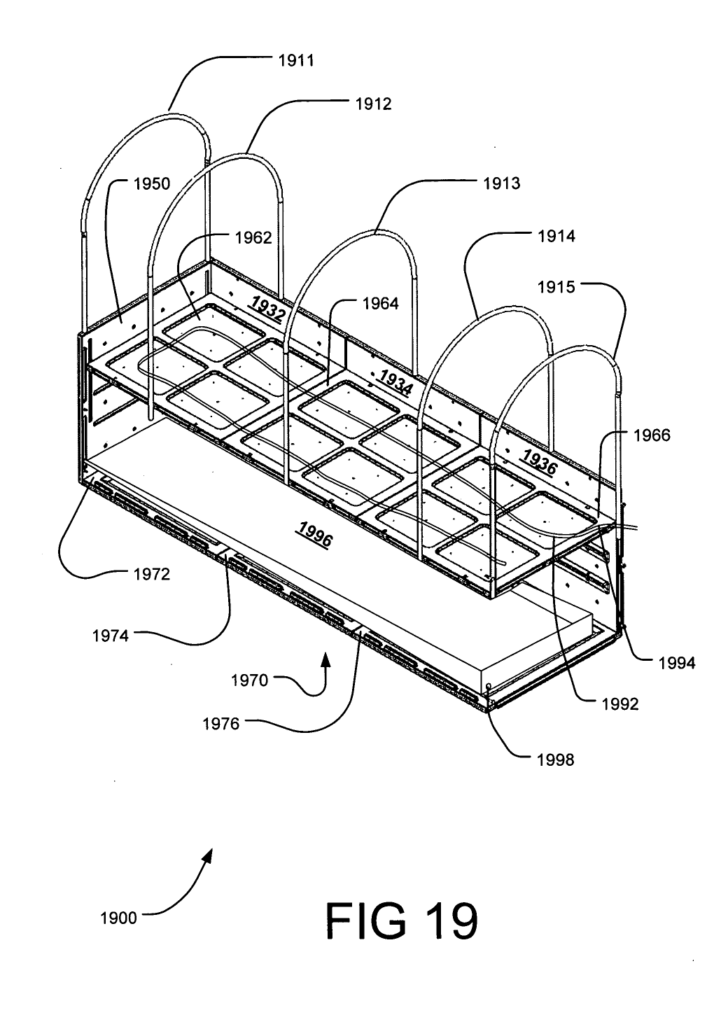

FIG. 19 illustrates a perspective view of an exemplary embodiment of a modular expandable growing season augmentation system 1900 showing one embodiment of a growth medium heating system with the cover, front and right sides removed. The heating system wires 1992 and 1994 shown in FIG. 19 can be run in the growth medium (preferably near the bottom where the growth medium contacts the shelf panels) in order to provide a heat source to ensure that the growing plants are not damaged by cold temperatures. Other types of heat systems may be employed in other embodiments.

FIG. 19 also illustrates one embodiment of a water collection tray 1996 installed in the bottom of the system. The tray 1996 is designed to collect any excess water that runs off from the shelf panels 1962, 1964 and 1966 above so that the water is contained in the system and does not leak out onto the ground, deck, floor, or other surface upon which the system rests. A built-in drain 1998 can be attached to the tray 1996 for attachment of a drain pipe or hose. In another embodiment, a pump is attached instead allowing a user to re-circulate the water back up to the plants and growth medium positioned on the shelf panels.

The bottom panels 1970 (comprising the left bottom panel 1972, the center bottom panel 1974, and the right bottom panel 1976), left side panel 1950, left rear panel 1932, center rear panel 1934, right rear panel 1936, left shelf panel 1962, center shelf panel 1964, and right shelf panel 1966 are all illustrated in FIG. 19. Also shown in FIG. 19 are the hoop cover support structures 1911, 1912, 1913, 1914, and 1915. These hoops extend down, into the front, rear and side panels and can be extended or retracted in order to raise or lower, respectively, the cover. Furthermore, the hoops 1911-1915 can be completely removed along with the cover if desired. Although not shown in FIG. 19, the hoops can also provide support points for hanging or attaching grow lights and/or heat elements inside the system 1900. Such enhancements can be automatically controlled via timers, thermostats, etc. Additionally, a watering subsystem, fertilizing subsystem, pest control subsystem, humidifier, dehumidifier, and/or air conditioning unit can be added to the system 1900 as well.

The above specification, examples and data provide a description of the structure and use of exemplary implementations of the described articles of manufacture and methods. It will further be understood from the foregoing description that various modifications and changes may be made in the embodiments of the present invention without departing from its true spirit. This description is intended for purposes of illustration only and should not be construed in a limiting sense. The scope of this invention should be limited only by the language of the following claims.

What is claimed is:

1. A modular expandable growing season augmentation system for growing plants, comprising:
a plurality of front panels, a plurality of rear panels, a plurality of side panels, and a plurality of bottom panels, wherein the plurality of front panels, the plurality of rear panels, the plurality of side panels, and the plurality of bottom panels are removably attached to one another via a plurality of attachments to form a generally rectangular box defining an interior space;
a plurality of shelf panels that can adjustably fit within the interior space and provide a generally horizontal surface on which a growth medium is held, the growth medium being designed to nurture and grow plants;
an adjustable cover designed to be raised or lowered as needed; and
wherein the panels are designed to be modular such that the rectangular box can be lengthened by adding additional panels to the system.

2. The modular expandable growing season augmentation system of claim 1, wherein the cover is further designed to let light pass through it and enter the system and the cover has a plurality of access ports that can be opened in order to provide access to the interior space.

3. The modular expandable growing season augmentation system of claim 1 wherein the cover has a ventilation port.

4. The modular expandable growing season augmentation system of claim 2 wherein the cover has a ventilation port.

5. The modular expandable growing season augmentation system of claim 1 wherein a plurality of hoop cover support structures support and hold the cover, the plurality of hoop cover support structures extend down into the panels and can be extended or retracted to raise or lower, respectively, the cover.

6. The modular expandable growing season augmentation system of claim 2 wherein a plurality of hoop cover support structures support and hold the cover, the plurality of hoop cover support structures extend down into the panels and can be extended or retracted to raise or lower, respectively, the cover.

7. The modular expandable growing season augmentation system of claim 1 wherein a plurality of shelf support members are configured into at least the plurality of front panels and the plurality of rear panels and are designed to strengthen the panels, add rigidity thereto, and support the plurality of shelf panels thereon.

8. The modular expandable growing season augmentation system of claim 6 wherein a plurality of shelf support members are configured into at least the plurality of front panels and the plurality of rear panels and are designed to strengthen the pluralities of front and rear panels, add rigidity thereto, and support the plurality of shelf panels thereon.

9. The modular expandable growing season augmentation system of claim 1 wherein a plurality of vertical support tabs extend generally upwards from each of the plurality of bottom panels and fit into a bottom edge of each of the plurality of front panels and the plurality of rear panels to help strengthen the plurality of attachments between the plurality of bottom panels and the pluralities of front and rear panels.

10. The modular expandable growing season augmentation system of claim 8 wherein a plurality of vertical support tabs extend generally upwards from each of the plurality of bottom panels and fit into a bottom edge of each of the plurality of front panels and the plurality of rear panels to help strengthen the plurality of attachments between the plurality of bottom panels and the plurality of front panels and between the plurality of bottom panels and the plurality of rear panels.

11. The modular expandable growing season augmentation system of claim 1 wherein the plurality of shelf panels each include a plurality of strengthening members designed to add strength and rigidity thereto.

12. The modular expandable growing season augmentation system of claim 10 wherein the plurality of shelf panels each include a plurality of strengthening members designed to add strength and rigidity thereto.

13. The modular expandable growing season augmentation system of claim 12 wherein the plurality of strengthening members and the plurality of shelf support members are similar such that the plurality of shelf panels can be interchanged with the plurality of front panels and with the plurality of rear panels without significantly degrading a functionality of the system.

14. The modular expandable growing season augmentation system of claim 1 wherein a standard panel can be substituted for each panel of the plurality of shelf panels, the plurality of front panels, and the plurality of rear panels, the standard panel having a plurality of shelf supports which also function as strengthening members, a plurality of structural tabs which strengthen the plurality of attachments between panels, a plurality of slots for receiving the structural tabs of a second standard panel therein, and a plurality of bottom slots for receiving a plurality of vertical support tabs therein, the plurality of vertical support tabs extending upwards from each of the plurality of bottom panels.

15. The modular expandable growing season augmentation system of claim 12 wherein a standard panel can be substituted for each panel of the plurality of shelf panels, the plurality of front panels, and the plurality of rear panels, the standard panel having a plurality of shelf supports which also function as strengthening members, a plurality of structural tabs which strengthen the plurality of attachments between panels, a plurality of slots for receiving the structural tabs of a second standard panel therein, and a plurality of bottom slots for receiving a plurality of vertical support tabs therein, the plurality of vertical support tabs extending upwards from each of the plurality of bottom panels.

16. The modular expandable growing season augmentation system of claim 14 wherein the plurality of end panels each has a plurality of slots for receiving therein the plurality of structural tabs from the standard panel and wherein the plurality of end panels each has a plurality of end panel tabs designed to fit within the plurality of slots on the standard panel.

17. The modular expandable growing season augmentation system of claim 15 wherein the plurality of end panels each has a plurality of slots for receiving therein the plurality of structural tabs from the standard panel and wherein the plurality of end panels each has a plurality of end panel tabs designed to fit within the plurality of slots on the standard panel.

18. The modular expandable growing season augmentation system of claim 16 wherein the plurality of bottom panels each has a bottom horizontal slot and a bottom horizontal tab wherein the bottom horizontal slot is designed to receive therein a second bottom horizontal tab from another bottom panel.

19. The modular expandable growing season augmentation system of claim 17 wherein the plurality of bottom panels each has a bottom horizontal slot and a bottom horizontal tab wherein the bottom horizontal slot is designed to receive therein a second bottom horizontal tab from another bottom panel.

20. The modular expandable growing season augmentation system of claim 19 further comprising:
a growth medium heating system designed to provide a heat source to ensure that the growing plants are not damaged by cold temperatures; and
a water collection tray designed to collect any excess water that runs off from the plurality of shelf panels.
